(19) United States
(12) Patent Application Publication
(10) Pub. No.: US 2015/0104763 A1
(43) Pub. Date: Apr. 16, 2015

(54) TEACHING STUDENTS TO RECOGNIZE AND CORRECT SENTENCE FRAGMENTS

(71) Applicant: Apollo Group, Inc., Phoenix, AZ (US)

(72) Inventors: BOB HAUSMANN, Swissvale, PA (US); ALISON HUETTNER, Pittsburgh, PA (US); ANDREYA PIPLICA, Pittsburgh, PA (US); RYAN SCHWIEBERT, Pittsburgh, PA (US); MICHAEL WASSON, Pittsburgh, PA (US)

(21) Appl. No.: 14/305,164

(22) Filed: Jun. 16, 2014

Related U.S. Application Data
(60) Provisional application No. 61/890,875, filed on Oct. 15, 2013.

(51) Int. Cl. G09B 19/04; G09B 7/08

(52) U.S. Cl. CPC G09B 19/04; G09B 7/08
USPC 434/169

(57) ABSTRACT

A method is provided for teaching students to recognize and correct incomplete sentences (also referred to herein as “sentence fragments”). A user is presented with one or more user interfaces that teach a user to determine whether a sentence is a complete sentence or an incomplete sentence. The interface may present an explanation as to why the sentence is a complete sentence or an incomplete sentence. To help a user deduce whether a sentence is a complete sentence or an incomplete sentence, one or more interfaces may present a user with one or more detailed questions about the sentence. The one or more detailed questions may ask the user to identify one or more particular features and/or words in the sentence. A user may be presented with one or more user interfaces that teach the user how to produce a complete sentence from a sentence fragment.

### BENEFIT CLAIM

This application claims the benefit of U.S. Provisional Application No. 61/890,875, filed Oct. 15, 2013.

### FIELD OF THE INVENTION

The present invention relates to teaching grammar and, more specifically, to teaching students to recognize and correct sentence fragments.

### BACKGROUND

Spoken language is fundamentally different from written language. Those transitioning to written language often write as they would speak. However, spoken language often includes sentence fragments and run-on sentences, which are likely to surface in writing. For example, a student with a poor grasp of what constitutes a sentence may unwittingly end a sentence before it is complete.

Conventionally, instructional grammar programs try to teach students how to identify complete sentences and incomplete sentences by presenting a user with one or more complete sentences and one or more incomplete sentences. The grammar programs may ask the user to correctly identify which sentences are complete and which sentences are incomplete.

Other programs may present a student with a sentence fragment along with one or more sequences of words that include the fragment. The programs may ask the student to identify which sequence of words, of the one or more sequences of words, is a complete sentence.

Having students merely identify which sentences are complete or incomplete may not teach the students the relevant underlying grammar principles. Furthermore, one student may struggle with different grammar principles than another student. Thus, a grammar program that tailors its instruction to each student may be helpful.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a process for teaching students to recognize complete and incomplete sentences, according to an embodiment.

FIG. 2 illustrates a user interface for teaching a student to determine whether a sentence is complete or incomplete, according to an embodiment.

FIG. 3 illustrates a user interface for teaching a student to identify one or more parts of a sentence using a sequence of questions, according to an embodiment.

FIG. 4 illustrates a user interface for presenting supplemental information to a user, in an example embodiment.

FIG. 5 illustrates a process for teaching a student to identify how a sentence fragment may be corrected to be a complete sentence, according to an embodiment.

FIG. 6 illustrates a user interface for teaching students to identify how a sentence fragment is corrected to be a complete sentence, according to an embodiment.

FIG. 7 is a block diagram that illustrates a computer system upon which an embodiment of the invention may be implemented.

While the figures listed above illustrate one or more embodiments for purposes of illustrating a clear example, other embodiments may omit, add to, reorder and/or modify any of the elements shown. For purposes of illustrating clear examples, one or more figures may be described with reference to one or more other figures, but using the particular arrangement illustrated in the one or more other figures is not required in other embodiments.

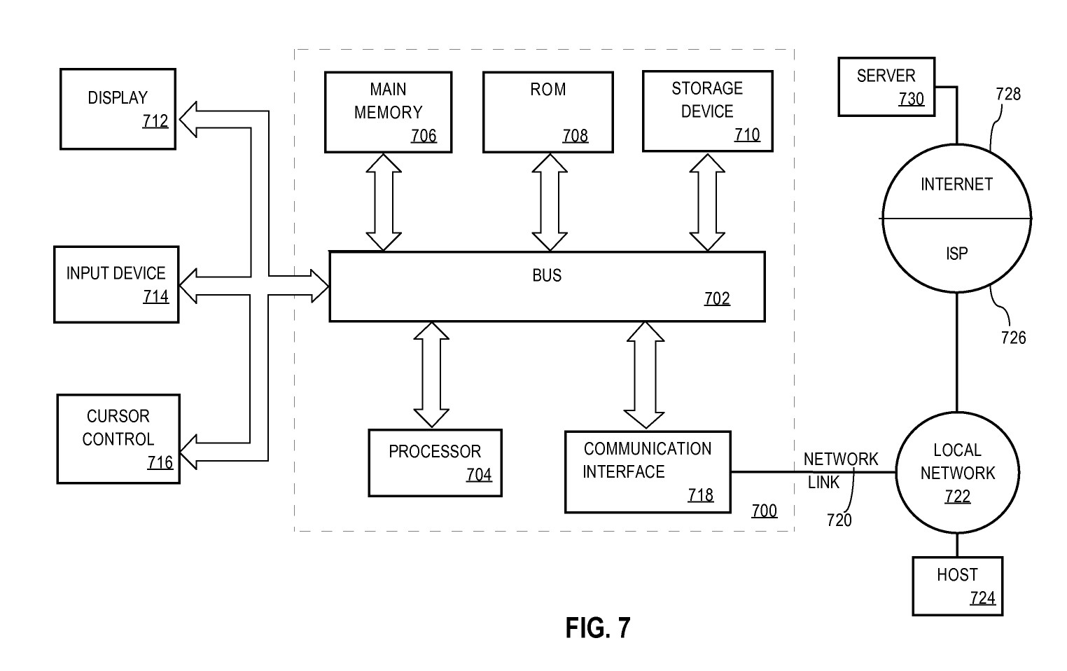

In an embodiment, one or more of the steps, modules, and/or systems discussed herein, may be implemented using any of the techniques further described herein in connection with FIG. 7. For example, the computer executing the instructional adaptive grammar module may comprise a general-purpose computer configured to perform, or cause another computer and/or device to perform, one or more of the methods discussed herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods and systems are provided for teaching students to recognize and correct incomplete sentences (also referred to herein as “sentence fragments”). A user is presented with one or more user interfaces that teach a user to determine whether a sentence is a complete sentence or an incomplete sentence. The interface may present an explanation as to why the sentence is a complete sentence or an incomplete sentence. For convenience of expression, a “sentence” may mean a sequence of words that form either a complete sentence or an incomplete sentence.

To help a user deduce whether a sentence is a complete sentence or an incomplete sentence, one or more interfaces may present a user with one or more detailed questions about the sentence. The one or more detailed questions may ask the user to identify one or more particular features and/or words in the sentence. After answering the one or more detailed questions, the user may deduce, and/or be presented with, an explanation as to why the sentence is complete or incomplete based on the detailed questions and the corresponding answers.

A user may be presented with one or more user interfaces that teach the user how to produce a complete sentence from a sentence fragment. For example, the user may be presented with one or more interfaces that present a complete sentence and identifies a sentence fragment within the complete sentence. The one or more interfaces may ask the user to determine which fragment-fixing technique was used to produce the complete sentence from the sentence fragment.

### Determining Whether a Sentence is Complete or Incomplete

One or more of the methods and/or systems discussed herein may be used to teach a student to determine whether a sentence is complete or incomplete. If a student incorrectly identifies a sentence to be complete or incomplete, the student may be presented with a series of questions, which ask the student to identify one or more parts in the sentence. Additionally or alternatively, a student may request to work through the series of questions before identifying whether the whole sentence is complete or incomplete. Based, at least in part, on one or more questions in the series of questions, the sentence may be identified as complete or incomplete. One or more of the methods and/or systems discussed herein, including one or more questions in the series of questions, may be tailored to help students identify and fix particular types of sentence fragments and/or other grammatical errors.

### Presenting One or More Sentences and/or Sentence Fragments

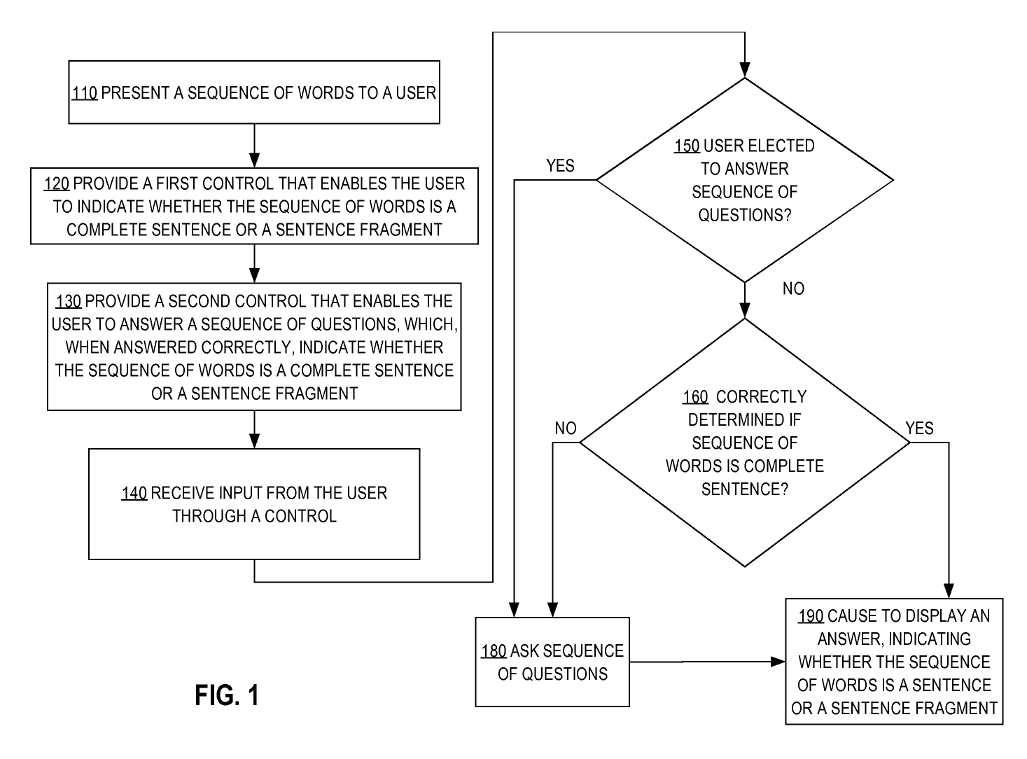

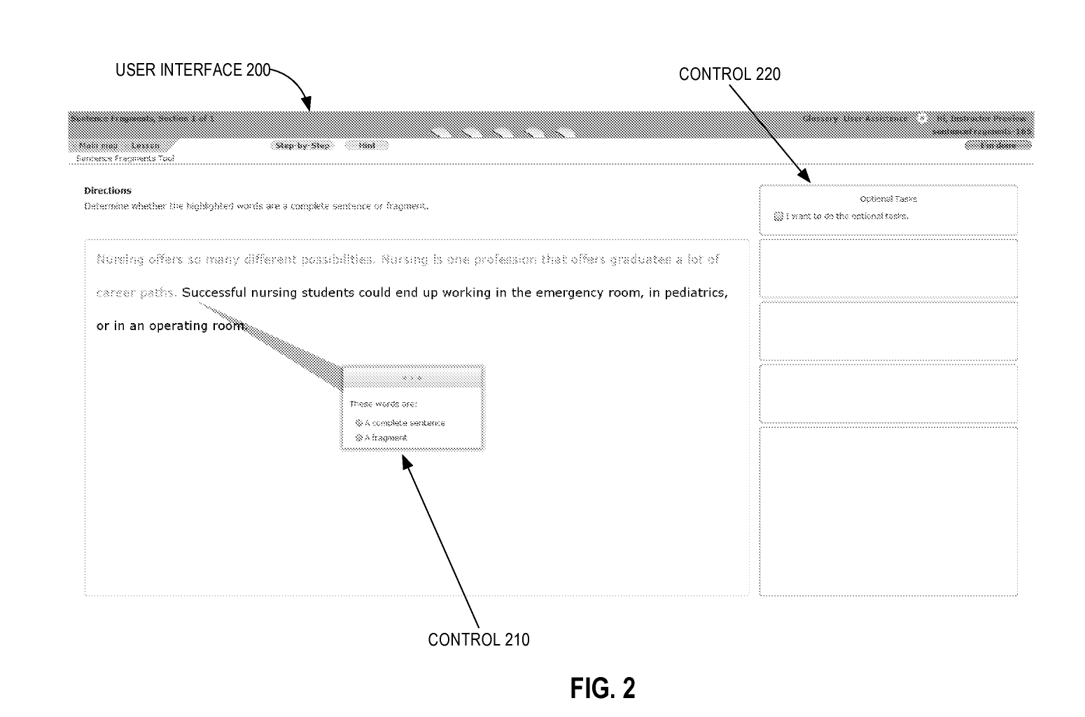

FIG. 1 illustrates a process for teaching students to recognize complete and incomplete sentences, according to an embodiment. In step 110, an instructional grammar module executed by, and/or communicatively coupled to, a computer system, such as computer system 700, presents a sequence of words to a user. For example, the grammar module may cause a display, communicatively coupled to the computer, to display the user interface (“UI”) illustrated in FIG. 2. FIG. 2 illustrates a user interface for teaching a student to determine whether a sentence is complete or incomplete, according to an embodiment. FIG. 2 includes UI 200, control 210, and control 220. UI 200 includes a bolded sequence of words that a user may determine to be a complete sentence or an incomplete sentence. The grammar module may present one or more of the interfaces and/or control through one or more output devices. For example, the grammar module may cause a sequence of words and/or questions to be played over a speaker. The grammar module may be used to teach one or more particular types of sentence fragments.

A module may be one or more hardware components. Additionally or alternatively, a module may be one or more instructions and/or operations executed on one or more hardware components. A hardware component may be a computer and/or computing system, such as computer system 700, which is discussed in detail below. A hardware component may comprise, and/or be communicatively coupled to, one or more output devices, such as a display, monitor, printer, and/or speakers, for presenting content to a user. Additionally or alternatively, a hardware component may comprise, and/or be communicatively coupled to, one or more input devices, such as a mouse, keyboard, touch screen, and/or microphone, for receiving input from a user.

The grammar module may be executed on a server computer, which generates instructions, such as HyperText Markup Language (HTML), Cascading Style Sheets (CSS), and/or JavaScript that define one or more user interfaces discussed herein. A client application, such as a browser executed on a client computer, may send data (such as a user's input or response) to, and/or requests for data (such as a new question) from, the grammar module on the server computer. In response, the grammar module may perform one or more of the methods discussed herein and/or send additional instructions to be executed by the browser. Additionally or alternatively, a grammar module may be executed partially and/or entirely on a user's computer and may perform one or more of the methods discussed herein and/or cause to display, and/or receive input through, one or more of the user interfaces discussed herein.

As illustrated in FIG. 2, the grammar module may cause more than one sentence to be displayed. However, the grammar module may indicate which particular sentence that the user should determine to be complete or incomplete. For example, in UI 200, three sentences are displayed. One of the three sentences is bolded, indicating to the user that the questions presented are based on the bolded sentence. The additional sentences may be helpful in subsequent questions. For example, if the bolded sentence is an incomplete sentence, then one solution to fix the incomplete sentence may be to combine the bolded sentence with a previous sentence that is not bolded.

### Providing Controls to Answer Questions about a Sentence or Sentence Fragment

In step 120, the grammar module provides a first control that enables the user to indicate whether the sequence of words is a complete sentence or a sentence fragment. For example, UI 200 includes control 210. Control 210 includes a set of radio buttons that allow a user to select one of two options: (1) the bolded words are a complete sentence; or (2) the bolded words are an incomplete sentence (also known as a sentence fragment). Other embodiments may include one or more other types of controls. For example, control 210 may be a single check box to indicate the sequence of words is a complete sentence or not. Control 210 may also include a button to submit, save, and/or send the user's response and/or selection.

In step 130, the grammar module provides a second control that enables the user to answer a sequence of questions, which when answered correctly indicates whether the sequence of words is a complete sentence or a sentence fragment. For example, UI 200 includes control 220. Control 220 includes a checkbox for “optional tasks”, which when selected indicates that the user wants to proceed through a series of questions to identify features of a sentence to determine whether the sentence is a complete sentence or a sentence fragment. In an embodiment, control 210 and control 220 may be part of the same control and/or displayed together.

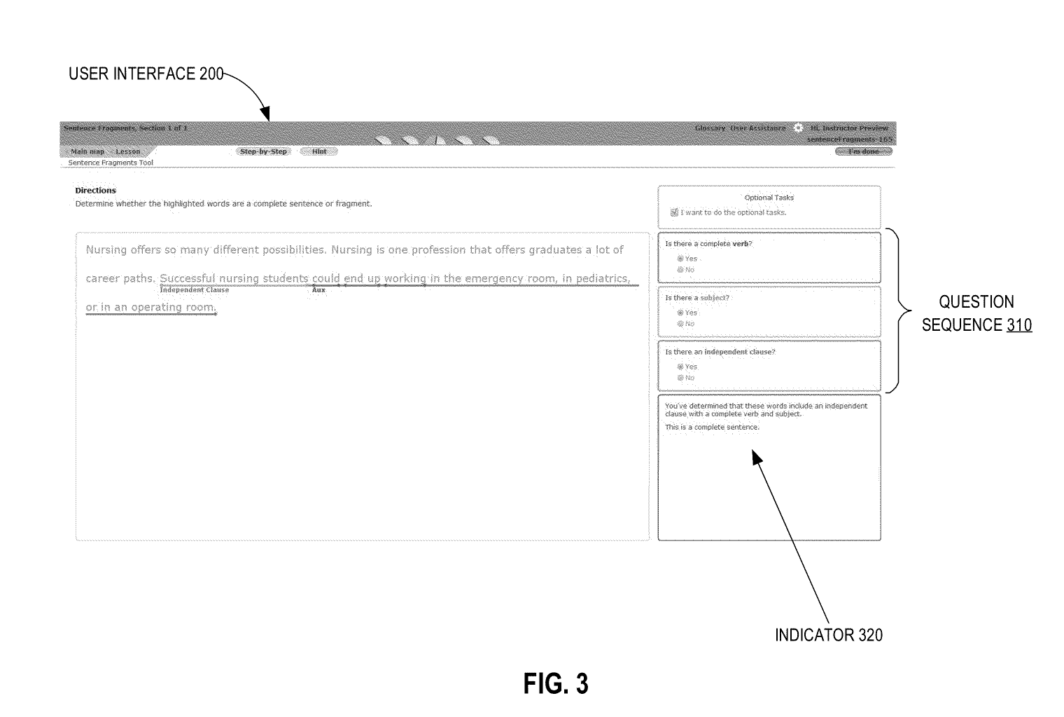

The grammar module may enable the user to answer the sequence of questions before the user uses the first control to indicate whether the sequence of words is a complete sentence or a sentence fragment. For example, UI 200 may allow a user to select the checkbox in control 220 before selecting a radio button in control 210. If the user selects the correct answer, then the grammar module may display and/or select control 220. Additionally or alternatively, if the user selects the correct answer in control 210, then the grammar module may display each question, in the series of questions, the answer(s) associated with each question, and/or indicators associated with each question, as shown in the example embodiment illustrated in FIG. 3 and discussed later herein. Additionally or alternatively, if the user selects the correct answer in control 210, then the answer(s) to each question in the series of questions may be selected, marked, and/or in some other way visually modified to indicate which answer(s) are correct and/or which answer(s) are not.

The grammar module may display and/or enable control 220 after a user selects an answer in control 210, regardless of whether the answer selected in control 210 is correct. Thus, the grammar module may force a user to select an answer before additional help is given. However, if the user feels unsure about a selected answer, even after receiving an indication that the answer is correct, then the user may elect, through control 220, to answer the series of questions. The series of questions may identify one or more parts in the sentence and may be used to determine whether the sentence is a complete sentence or sentence fragment.

The grammar module may require the user to determine whether the sentence is a complete sentence or a sentence fragment before the user can elect whether the user would like to answer the sequence of questions. For example, the grammar module need not display and/or enable control 220 unless the user incorrectly answers the question presented in control 210. Alternatively, the grammar module may display and/or enable control 210 after a user opts-in or opts-out of answering the sequence of questions through control 220.

### Responding to One or More User Inputs

In step 140, the grammar module receives input from the user through a control. For example, the grammar module may receive input through UI 200, when the user selects an input in control 210 and/or control 220. The grammar module may receive the input through a keyboard, mouse, touch screen, microphone, and/or any other input device.

In step 150, the grammar module determines whether the user opted to answer the sequence of questions. If so, then control passes to step 180. Otherwise, control passes to step 160. For example, the grammar module may receive input indicating that a user selected the checkbox for optional tasks in control 220. If so, then the grammar module passes to step 180.

In step 160, the grammar module determines whether the user correctly determined if the sequence of words was a complete sentence or sentence fragment. For example, if the grammar module receives input indicating that a user selected the radio button that corresponds with “a fragment” in control 210 and the bolded sentence is a complete sentence, then the grammar module passes to step 180. Otherwise, the grammar module passes to step 190. Similarly, if the grammar module receives input indicating that the user selected the radio button that corresponds with “a complete sentence” and the bolded sentence is a sentence fragment, then the grammar module may pass to step 180. Otherwise, the grammar module passes to step 190.

### Identifying Particular Parts in a Complete Sentence or Sentence Fragment

In step 180, the grammar module asks a sequence of questions. FIG. 3 illustrates a user interface for teaching a student to identify one or more parts of a sentence using a sequence of questions, according to an embodiment. FIG. 3 includes UI 200 and question sequence 310. For purposes of illustrating a clear example, the questions in question sequence 310 are presented at the same time. However, in an embodiment, the first question, “Is there a complete verb”, is presented before the other questions in question sequence 310. After the grammar module receives input from the user answering the first question, then the second question is presented: “Is there a subject?”

The sequence of questions may comprise one or more questions presented in a particular order. For example, the first question may ask the user to determine whether a sequence of words includes a verb. If so, then the second question may be whether the sequence of words includes a subject. If so, then the third question may be whether the sequence of words includes an independent clause. Additionally or alternatively, one or more other questions may be presented to a user to determine whether the sequence of words is a complete sentence or a sentence fragment.

If the answer to any of the first three questions above is no, then the sentence is a fragment. Thus, the grammar module need not continue to ask subsequent questions. For example, if the correct answer to “Does this phrase have a subject?” is no, then the grammar module may pass to step 190 without asking additional questions. However, in an embodiment, to help the one or more students identify particular parts of a sentence and/or to demonstrate relationships between parts of a sentence, the grammar module may proceed to pose additional questions to the user. For example, a complete sentence has a subject and a verb. A subject is a noun, or noun phrase, that is paired with a verb. Continuing to ask a user whether there is a subject after determining that there is no verb may help a user understand that a noun, and/or a noun phrase, cannot be a subject without a corresponding verb.

Each question in the sequence of questions may be assigned a particular color, and the part(s) of the sentence that correspond with the question may be highlighted and/or emphasized with the same color. For example, the first question in question sequence 310 is outlined in blue. Accordingly, the words that comprise the complete verb are underlined in blue. The question may be assigned a particular color after the question is answered correctly. For example, the grammar module may color the border of the surrounding box after the grammar module receives input indicating that a user selected the correct answer. Additionally or alternatively, a key word in the question may be highlighted in the same color. For example, in the first question, the word “verb” is also colored in blue.

A label corresponding to a key word and/or question may be presented. For example, a label with the word “Aux”, which is short for “auxiliary verb”, and which corresponds with the first question, is presented in the sentence under a word that is an auxiliary verb: “could”. The label may include the same color as the corresponding question and/or key word. For example “Aux” is blue, which is the same color associated with the first question. As illustrated, the label may include information to help users identify parts of a sentence.

A question may be presented and answered before the corresponding words, if any, are highlighted. For example, the grammar module need not underline “could end up working” in blue, and/or include the “Aux” label, until after the user selects the correct answer to the first question.

The grammar module may repeat one or more of the methods discussed herein for each question in question sequence 310. For example, after the grammar module receives input indicating a user selected the correct answer to the first question, then the grammar module may perform the same one or more steps with the second question: “Is there a subject?” Each question may correspond with a different color. For example, in FIG. 3, the first question is associated with blue, the second question is associated with yellow, and the third question is associated with green.

After each question in the sequence of questions is answered, the grammar module may present indicator 320. Indicator 320 describes why the sentence is either a complete sentence or a sentence fragment based, at least in part, on the answers to one or more of the questions in question sequence 310. For example, indicator 320 states that the bolded words in FIG. 2 comprise a complete sentence because each of the things in question sequence 310 is included in the corresponding sentence.

### Presenting Supplemental Information in Response to Input Indicating a User Selected an Answer

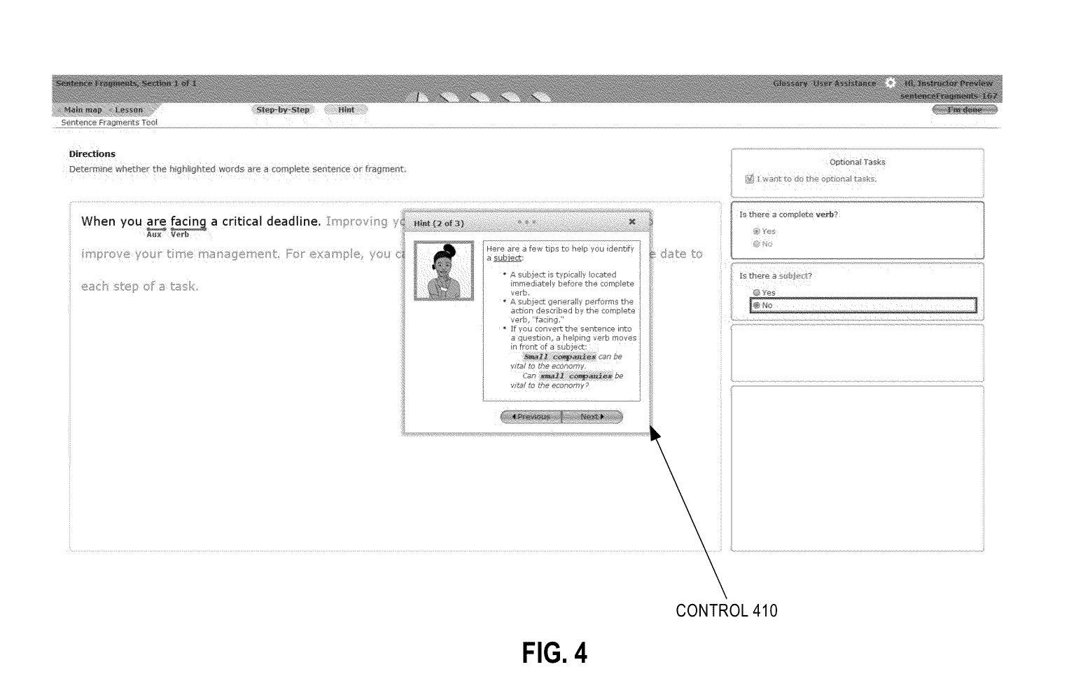

If a user selects an incorrect answer, then additional information may be presented to teach the user how to identify the correct answer in the future. FIG. 4 illustrates a user interface for presenting supplemental information to a user, in an example embodiment. In FIG. 4, a grammar module received input that a user selected “No”, which is an incorrect answer to the second question: “Is there a subject?” In response, the grammar module presented the user with control 410. Control 410 describes what a subject is and gives some examples of a subject. Control 410 may be a dialog box and/or a separate application, such as a browser.

Control 410 may include links, buttons, and/or other controls, to be presented with additional learning resources, such as a glossary. For example, the word “subject” in control 410 may be a link to a glossary entry explaining what a subject is and how to identify a subject.

The grammar module may update a UI to indicate that a user selected an incorrect answer. For example, in FIG. 4, the grammar module causes the user's incorrect answer to be outlined in red. Also for example, the grammar module may cause a particular sound to be played with one or more speakers indicating that the wrong answer was selected.

The grammar module may update a UI to indicate that a user selected a correct answer. For example, the grammar module may present the next question and/or a conclusion in response to receiving input that the user selected the correct answer. Also for example, the grammar module may cause a particular sound to be played with one or more speakers indicating that the correct answer was selected.

In response to input indicating that a user selected a label, such as the “Aux” label, the grammar module may present additional information according to one or more of the methods discussed herein. For example, the grammar module may present a dialog box that content describing what an auxiliary verb is. Additionally or alternatively, the grammar module may open a separate application, such as a browser, and present the additional information in the browser.

### Deducing a Conclusion

Returning now to FIG. 1, in step 190, the grammar module causes to display an answer, indicating whether the sequence of words is a sentence or a sentence fragment and explains why. For example, the grammar module may cause indicator 320 to be displayed.

The grammar module may cause to display the correct answer to each question in the sequence of questions and indicates the correct conclusion based on the answer to each question in the sequence of questions. For purposes of illustrating a clear example, assume that the grammar module received input indicating that a user selected “A complete sentence” in control 210, which is displayed in FIG. 2, in step 140. In response, to determining the correct answer was selected, the grammar module may update UI 200 in FIG. 2, to UI 200 in FIG. 3, in which each question in question sequence 310 is displayed, the radio button corresponding to the correct answer for each question is selected, and indicator 320 is displayed. Additionally or alternatively, one or more of the other methods discussed herein may be performed. For example, the grammar module may highlight the parts of the sentence that correspond with each question in question sequence 310.

One or more of the methods discussed herein may be used to help a user become more aware of particular words and/or parts of a sentence. Thus, the grammar module, or one or more of the methods discussed herein, may be used by a grammar module to teach one or more other grammar concepts.

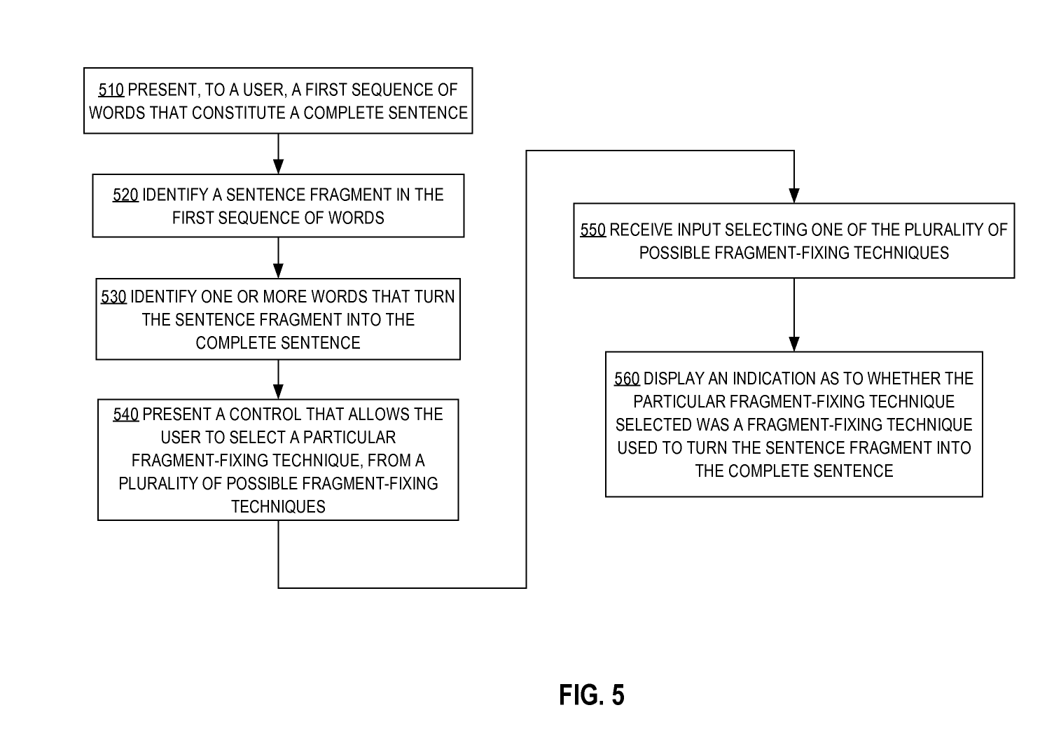

The grammar module may continue to teach a user to identify complete sentence, sentence fragment, and/or any other part of a sentence by repeating one or more of the steps above for a different sequence of words. Additionally or alternatively, if the sequence of words is a sentence fragment, then the grammar module may proceed to perform one or more of the steps illustrated in FIG. 5 to teach a student how to correct the sentence fragment.

### Teaching a User to Correct a Sentence Fragment

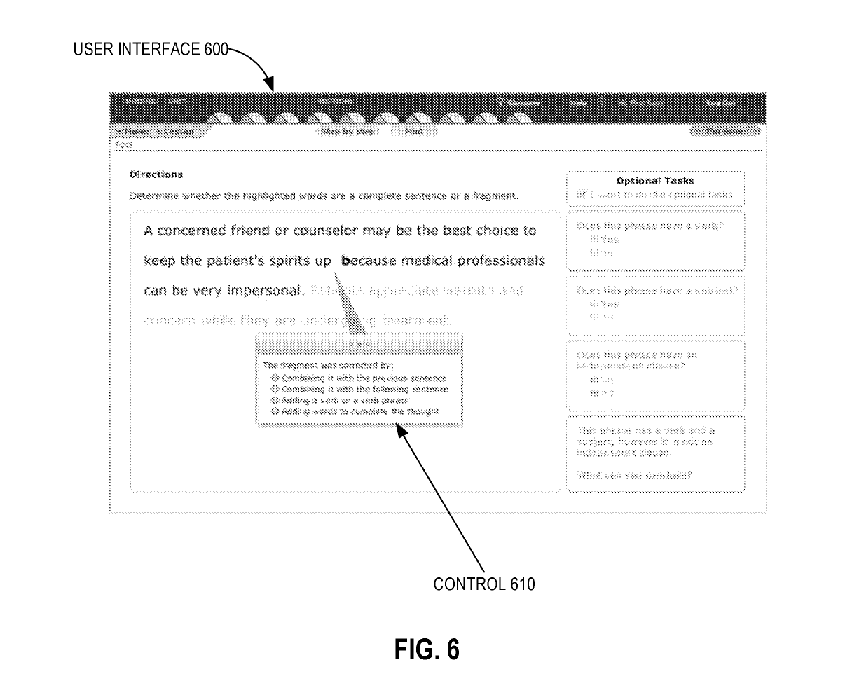

One or more techniques may be used to produce a complete sentence from a sentence fragment. FIG. 5 illustrates a process for teaching a student to identify how a sentence fragment may be corrected to be a complete sentence, according to an embodiment. In step 510, a grammar module presents a first sequence of words that constitutes a complete sentence. For example, the grammar module may cause a display, communicatively coupled to a computer system, to display the UI illustrated in FIG. 6. FIG. 6 illustrates a user interface for teaching students to identify how a sentence fragment is corrected to be a complete sentence, according to an embodiment. FIG. 6 includes UI 600, which comprises control 610.

In step 520, the grammar module identifies a sentence fragment in the first sequence of words. For example, in UI 600, the grammar module causes the following words to be black: “because medical professionals can be very impersonal”.

In step 530, the grammar module identifies one or more words that turn the sentence fragment into the complete sentence. For example, in UI 600, the grammar module causes the following words to be black: “A concerned friend or counselor may be the best choice to keep the patient's spirits up”.

The grammar module may cause one or more words that are not part of the sequence of words, which constitute the complete sentence, to be less emphasized. For example, the grammar module may cause the following sentence to be displayed is a lighter color: “Patients appreciate warmth and concern while they are undergoing treatment”.

In step 540, the grammar module presents a control that allows the user to select a particular fragment-fixing technique, from a plurality of possible fragment-fixing techniques. For example, the grammar module may cause control 610 to appear in UI 600. Control 610 may include a list of possible fragment-fixing techniques, such as, (1) combining a sentence fragment with a previous sentence and/or sentence fragment, (2) combining a sentence fragment with a following sentence and/or sentence fragment, (3) adding a verb or a verb phrase, and (4) adding words to complete a thought expressed in a sentence fragment. Additionally or alternatively, control 610 may include a list of one or more other possible solutions.

The grammar module may also emphasize changes from a previous state. For purposes of illustrating a clear example, assume:
(1) The text previously presented in UI 600 was “A concerned friend or counselor may . . . keep the patient's spirits up. Because medical professionals can be very impersonal.”
(2) The grammar module fixed the second sentence, so that the second sentence is no longer a sentence fragment rather than a complete sentence, as illustrated in UI 600 of FIG. 6.
(3) The grammar module, as part of fixing the second sentence, replaced the “B” in “Because” with a lowercase “b”.

The grammar module may update the changed text as illustrated in UI 600 in FIG. 6. For example, the grammar module may cause the “b” in “because” to be bolded to indicate the “b” was changed from uppercase to lowercase. Additionally or alternatively, the grammar module may cause an extra space to be inserted between “up” and “because”, indicating that there used to be a period after “up”. Additionally or alternatively, the grammar module may use a directional indicator to point a part of the text that changed. For example, control 610 has a grey triangle that points a portion of the text that changed to produce a complete sentence from the previous sentence fragment.

In step 550, the grammar module receives input selecting a fragment-fixing technique of the plurality of possible fragment-fixing techniques. For example, the grammar module may receive input indicating that a user selected “Combining it with the previous sentence”.

In the embodiment illustrated in FIG. 6, control 610 and/or the grammar module may limit a user to selecting one fragment fixing technique. Additionally or alternatively, control 610 and/or the grammar module may allow a user to select one or more fragment-fixing techniques that the user believes were used to fix a sentence fragment. Additionally or alternatively, each fragment-fixing technique may include one or more fragment fixing techniques.

Additionally or alternatively, control 610 may allow a user to produce a complete sentence from a sentence fragment. However, a sentence fragment may be fixed in numerous ways. Programming the grammar module to verify that the user produced a complete sentence from the sentence fragment may be difficult. Thus, the grammar module may apply a fragment-fixing technique, as discussed herein and illustrated in FIG. 6, and a user may identify what fragment-fixing technique was used. Additionally or alternatively, control 610 may allow a user to select a fragment-fixing technique. In response, the grammar module may present complete sentence generated based on the selected fragment-fixing technique. The grammar module may include content indicating why the new complete sentence is a complete sentence based on the selected fragment-fixing technique.

In step 560, the grammar module causes to display an indication as to whether the particular fragment-fixing technique selected was a fragment-fixing technique used to turn the sentence fragment into the complete sentence. For example, the grammar module may cause a first color, such as green, to be displayed around and/or behind the correct answer. Additionally or alternatively, the grammar module may cause a second color, such as red, to be displayed around and/or behind an incorrect answer that was selected. Additionally or alternatively, the grammar module may cause text to be displayed in UI 600 that indicates how a particular fragment-fixing technique produced a complete sentence from the sentence fragment. Additionally or alternatively, the grammar module may cause an animation to play that illustrates how the fragment-fixing technique was used to fix the sentence fragment.

The grammar module may use one or more of the methods discussed herein to teach a user how to fix a particular sentence fragment, after performing one or more of the methods discussed herein to identify that the particular sentence fragment is indeed a fragment. For example, after receiving input from a user correctly identifying a sentence fragment as a fragment, the grammar module may fix a sentence fragment. The grammar module may use one or more of the methods discussed herein to teach a user which fragment-fixing technique was used.

### Adaptively Teaching Students to Recognize Complete Sentences and Sentence Fragments

The grammar module may perform one or more steps discussed above for one or more sequences of words. For example, after completing step 190 in FIG. 1, the grammar module may display a new sequence of words in UI 200 and repeat step 110 through step 190.

The grammar module may select which sequence of words to present to a user or student based on previous selections by the student. For example, sequences of words may be classified as one or more of the following: a complete sentence, a sentence fragment, a simple noun phrase sentence fragment, a sentence fragment with a noun phrase and a relative clause, a gerund phrase, a bare predicate, an unattached adverbial clause, and/or any other classification.

Each time the grammar module receives input indicating that the user correctly determined which class a sentence belongs to, the grammar module may show sentences in that class less often. For example, if the grammar module receives input indicating that a user correctly determined that a particular sequence of words is a complete sentence, then the grammar module may select sequences of words that form complete sentences less often.

Each time the grammar module receives input indicating that the user correctly determined which fragment-fixing technique was used to correct a sentence, the grammar module may display a complete sentence based on that fragment-fixing technique less often. For example, if the grammar module receives input indicating that a user correctly determined which particular technique was used to fix a sentence fragment, then complete sentences based on that particular technique may be presented to the user less often.

The grammar module may randomly select a sequence of words from a particular classification. Additionally or alternatively, the grammar module may track which sequences of words have already been presented to a user, and select a sequence of words, which has not already been shown to a user, from a particular class.

Two sequences of words may be similar but not identical. Showing sentences that are similar, but different, may help a user remain attentive to small changes that affect whether a sentence is a complete sentence or a sentence fragment.

### Generating Sentences

One or more sentences that a grammar module presents to a user may be crafted by a subject matter expert. The subject matter expert may craft a sentence and identify one or more classifications that the sentence belongs to

One or more sentences may be generated by the grammar module by modifying one or more stored sentences. For example, the grammar module may swap verbs, nouns, noun phrases, and/or any other part of a sentence. Also for example, the grammar module may also remove one or more parts of the sentence such as an independent clause.

The grammar module may store each sentence in a database. The grammar module may associate each sentence in the database with one or more classifications. A class may describe the type(s) of words and/or phrases in a sentence; the problem(s), if any, with a sentence; and/or any other type of problem and/or solution associated with the sentence.

Each incomplete sentence may also be associated with a fixed complete sentence. The incomplete sentence and the corresponding complete sentence may each be associated with one or more different classifications. For example, an incomplete sentence may be classified with one or more sentence fragment classes, such as “bare predicate”. The corresponding complete sentence may be classified with the “complete sentence” class, as well as one or more fragment-fixing techniques, such as “adding a subject”.

Additionally or alternatively, a sentence may include one or more keywords and/or tags that indicate what one or more particular words are, which one or more words may be substituted for another, and/or any other information. The following is an example sentence with markup identifying particular parts of a sentence:
[_subject]He[/_subject] [_aux]is[_/aux] [_verb]${writing}[/_verb] in a [_object]${book}[_/object].

In the example above, the markup identifies “He” as the subject. The grammar module may generate a new sentence by removing “He” or replacing “He” with a different subject, which could come from a variety of different sources, such as a database, file, dictionary, online resource, machine-learning algorithm run over a corpus of dialogs, and/or other local or remote data store. Also in the above example, the verb “writing” and the object “book” are marked with a leading “$” and surrounded by braces, indicating that they may be replaced with one or more words that are similar. For example, “${writing}” or “writing” may be associated with “drawing” or “scribbling”. Accordingly, to generate a new sentence, the grammar module may replace the word “writing” with “drawing” or “scribbling”. Additionally or alternatively, “${book}” or “book” may be associated with “notebook” or “journal”, and can be replaced by one of those words, generating still more variety.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
presenting a sequence of words to a user;
providing a first control that enables the user to indicate whether the sequence of words is a complete sentence or a sentence fragment;
providing a second control that enables the user to answer a sequence of questions, which, when answered correctly, indicate whether the sequence of words is a complete sentence or a sentence fragment;
wherein the sequence of questions comprises two or more questions;
enabling the user to answer the sequence of questions without having first used the first control to indicate whether the sequence of words is a complete sentence or a sentence fragment; and
wherein the method is performed by one or more computing devices.

2. The method of claim 1 further comprising, in response to receiving, through the first control, an incorrect indication that the sequence of words is a complete sentence, presenting the user with the sequence of questions.

3. The method of claim 1 further comprising:
receiving, through the second control, answers to the sequence of questions; and
highlighting a portion of the sequence of words that corresponds to the question after the user answers each question in the sequence of questions.

4. The method of claim 3 further comprising:
in response to the user correctly answering a first question in the sequence of questions, highlighting a first portion of the sequence of words in a first manner;
in response to the user correctly answering a second question in the sequence of questions, highlighting a second portion of the sequence of words in a second manner while the first portion continues to be highlighted in the first manner;
wherein the first manner is different than the second manner.

5. The method of claim 4 wherein highlighting the first portion in the first manner includes highlighting using a first color and highlighting in the second manner includes highlighting in a second color that is different than the first color.

6. The method of claim 1 further comprising, in response to the user using the first control to correctly indicate whether the sequence of words is a complete sentence or a sentence fragment without having answered the sequence of questions, displaying correct answers to each question in the sequence of questions.

7. The method of claim 1 comprising:
classifying each word sequence of a plurality word sequences in one or more classes;
for each class, determining a proficiency of the user based, at least in part, on one or more inputs indicating whether the user correctly identified one or more word sequences in the class;
selecting the sequence of words to present to the user based, at least in part, on the proficiency of the user in the class.

8. A method comprising:
presenting, to a user, a first sequence of words that constitute a complete sentence;
wherein the first sequence of words includes:
a second sequence of words that represent a sentence fragment; and
one or more additional words that turn the sentence fragment into the complete sentence;
presenting a control that allows the user to select a particular fragment-fixing technique, from a plurality of possible fragment-fixing techniques; and
in response to the user selecting the particular fragment-fixing technique, displaying an indication as to whether the particular fragment-fixing technique was a fragment-fixing technique used to turn the sentence fragment into the complete sentence.

9. The method of claim 8 comprising emphasizing one or more words in the first sequence of words indicating that a change was made to produce the first sequence of words.

10. The method of claim 8 comprising:
classifying each fragment-fixing technique in one or more classes;
for each class, determining a proficiency of the user based, at least in part, on one or more inputs indicating whether the user correctly identified the fragment-fixing technique in the class;
wherein the first sequence of words is associated with the particular fragment-fixing technique, which is associated with a particular class;
selecting the first sequence of words to present to the user based, at least in part, on the proficiency of the user to correctly identify fragment-fixing techniques in the particular class.

11. A system comprising:
a processor;
a memory; and
a grammar module configured to:
present a sequence of words to a user;
provide a first control that enables the user to indicate whether the sequence of words is a complete sentence or a sentence fragment;
provide a second control that enables the user to answer a sequence of questions, which, when answered correctly, indicate whether the sequence of words is a complete sentence or a sentence fragment;
wherein the sequence of questions comprises two or more questions;
enable the user to answer the sequence of questions without having first used the first control to indicate whether the sequence of words is a complete sentence or a sentence fragment.

12. The system of claim 11, wherein the grammar module is further configured to, in response to receiving, through the first control, an incorrect indication that the sequence of words is a complete sentence, present the user with the sequence of questions.

13. The system of claim 11, wherein the grammar module is further configured to
receive, through the second control, answers to the sequence of questions; and
highlight a portion of the sequence of words that corresponds to the question after the user answers each question in the sequence of questions.

14. The system of claim 13, wherein the grammar module is further configured to:
in response to the user correctly answering a first question in the sequence of questions, highlight a first portion of the sequence of words in a first manner;
in response to the user correctly answering a second question in the sequence of questions, highlight a second portion of the sequence of words in a second manner while the first portion continues to be highlighted in the first manner;
wherein the first manner is different than the second manner.

15. The system of claim 14, wherein highlighting the first portion in the first manner includes highlighting using a first color and highlighting in the second manner includes highlighting in a second color that is different than the first color.

16. The system of claim 11, wherein the grammar module is further configured to, in response to the user using the first control to correctly indicate whether the sequence of words is a complete sentence or a sentence fragment without having answered the sequence of questions, display correct answers to each question in the sequence of questions.

17. The system of claim 11, wherein the grammar module is further configured to:
classify each word sequence of a plurality word sequences in one or more classes;
for each class, determine a proficiency of the user based, at least in part, on one or more inputs indicating whether the user correctly identified one or more word sequences in the class;
select the sequence of words to present to the user based, at least in part, on the proficiency of the user in the class.

18. A system comprising:
a processor;
a memory; and
a grammar module configured to:
present, to a user, a first sequence of words that constitute a complete sentence;
wherein the first sequence of words includes:
a second sequence of words that represent a sentence fragment; and
one or more additional words that turn the sentence fragment into the complete sentence;
present a control that allows the user to select a particular fragment-fixing technique, from a plurality of possible fragment-fixing techniques; and
in response to the user selecting the particular fragment-fixing technique, display an indication as to whether the particular fragment-fixing technique was a fragment-fixing technique used to turn the sentence fragment into the complete sentence.

19. The system of claim 18, wherein the grammar module is further configured to emphasize one or more words in the first sequence of words indicating that a change was made to produce the first sequence of words.

20. The system of claim 18, wherein the grammar module is further configured to:
classify each fragment-fixing technique in one or more classes;
for each class, determine a proficiency of the user based, at least in part, on one or more inputs indicating whether the user correctly identified the fragment-fixing technique in the class;
wherein the first sequence of words is associated with the particular fragment-fixing technique, which is associated with a particular class;
select the first sequence of words to present to the user based, at least in part, on the proficiency of the user to correctly identify fragment-fixing techniques in the particular class.
